(19) United States
(12) Patent Application Publication
(10) Pub. No.: US 2025/0282108 A1
(43) Pub. Date: Sep. 11, 2025

(54) METHOD AND MOULD FOR FORMING A FIBER-REINFORCED DEVICE WITH ANGLE PLATE

(71) Applicant: 9T LABS AG, Zürich (CH)

(72) Inventors: Jonas BOSSHARD, Schaffhausen (CH); Jan ALTHERR, Zürich (CH); Martin EICHENHOFER, Zürich (CH); James LACKEY, Rafz (CH); Thomas NETTER, Winterthur (CH); Jordan KALMAN, Lowell, MA (US)

(73) Assignee: 9T LABS AG, Zürich (CH)

(21) Appl. No.: 18/862,527

(22) PCT Filed: May 2, 2023
(86) PCT No.: PCT/IB2023/054573

§ 371 Date: Nov. 2, 2024

(30) Foreign Application Priority Data
May 2, 2022 (WO) PCT/IB2022/054090
Sep. 28, 2022 (WO) PCT/IB2022/059264
Oct. 6, 2022 (WO) PCT/IB2022/059563
Dec. 8, 2022 (WO) PCT/IB2022/061935
Mar. 16, 2023 (WO) PCT/IB2023/052608
Apr. 18, 2023 (WO) PCT/IB2023/053974

(51) Int. Cl. B29C 70/46; B29C 70/22; B29L 31/30

(52) U.S. Cl. CPC B29C 70/46; B29C 70/222; B29L 2031/3076

(57) ABSTRACT

A method for forming a molded device comprising an angle plate, comprising: positioning in a mold ore or more first preform comprising a free first end and wherein the first preform comprises a first thermoplastic material and a plurality of elongated fibers; and positioning in the mold one or more filler comprising a second thermoplastic material; and compressing, by translating at least a first surface of the mold in at least a −Z-direction, the free first end of one or more of the first preform from a first position of the first end to a second position of the first end.

### FIELD

This disclosure relates to apparatuses and methods for forming a fiber-reinforced device, for example comprising an angle plate.

### SUMMARY

A problem identified by the present inventors relates to methods for forming angle plates, for example brackets, comprising fibers.

In one aspect, the present disclosure provides a method for forming a molded device comprising an angle plate, comprising: positioning in a mold one or more first preforms comprising a free first end and wherein the first preform comprises a first thermoplastic material and a plurality of elongated fibers; positioning in the mold one or more fillers comprising a second thermoplastic material; and compressing, by translating at least a first surface of the mold in at least a −Z-direction, the free first end of one or more of the first preforms from a first position of the first end to a second position of the first end, wherein during at least a portion of the duration of the compressing, the free first end is inclined towards the first surface of the mold; and the compressing forms: a buckling portion in the first preform from a buckling reference elevation; and a padding from at least a portion of the filler positioned against a curved portion of the buckling.

In another aspect, the present disclosure provides a molded device comprising an angle plate, comprising: one or more first preforms comprising a free first end and wherein the first preform comprises a first thermoplastic material and a plurality of elongated fibers; and one or more fillers comprising a second thermoplastic material, wherein the angle plate comprises: a buckling portion in the first preform from a buckling reference elevation; and a padding from at least a portion of the filler positioned against a curved portion of the buckling.

In yet another aspect, the present disclosure provides a mold system for forming a molded device comprising an angle plate, comprising: a first mold component comprising at least a first surface internal to the mold; a second mold component comprising one or more wells; and one or more actuators connected to one or more of the first mold component and the second mold component, wherein one or more of the first mold component and the second mold component comprises a guiding rail oriented along a Z-axis; and the one or more wells comprise one or more clamps in sliding contact with a guide rail oriented along an X-axis.

### BRIEF DESCRIPTION OF DRAWINGS

FIGS. 1A, 1B, 1C, 2A, 2B, 2C, 2D present side views or Z-X plane cross-sections of a mold system for forming a molded device.

FIGS. 1D, 1E, 1F, 1G are top views of a mortise and tenon arrangement.

FIG. 2D is a side view of a buckling portion.

FIG. 3A is a top view of a first preform with a crenelated contour.

FIG. 3B1 is a top view of tows in the contour of a first preform.

FIG. 3B2 is a top view of tows in a leg of a crenellation, one of the tows comprising 2 U-turns.

FIG. 3C is an X-Z plane cross-section of a mold system with a first preform with a crenelated contour.

FIG. 3D is a perspective view of a molded device comprising an angle plate formed using a first preform with a crenelated contour.

FIG. 3E is a top view of a first preform with a crenelated contour comprising a first preform component and a second preform component having endings in the crenelated portions.

FIG. 3F is a top view of a first preform having a crenelated contour comprising a first preform component and a second preform component having endings in the straight portions.

FIG. 3G is a top view of a first preform having a crenelated contour having endings extending parallel to each other.

FIG. 3H1 is a perspective view of a double-U preform comprising two opposite U-shaped geometries.

FIG. 3H2 is a perspective view of a double-U preform comprising a plurality of separate layers bonded by an interlayer.

FIG. 3I is a perspective view of a preform arrangement to form a molded device.

FIG. 3J is a perspective view of a molded device.

FIG. 4 is a block diagram of a control system for a system for forming a molded device.

FIG. 5A is a block diagram for a method for forming a molded device.

FIG. 5B is a block diagram for a method for forming a double-U preform.

FIG. 6 presents a perspective view of a molded device comprising an angle plate.

### DETAILED DESCRIPTION

Compression molding of materials comprising fibers and resins induces friction between the material being compressed and the system used for compressing the material. The friction induces, for example, a displacement, for example a flow of fibers and, in some examples, a rupture of fibers. This disclosure presents methods to improve compression molding processes applied to materials comprising fibers and resins, for example thermoplastic resins.

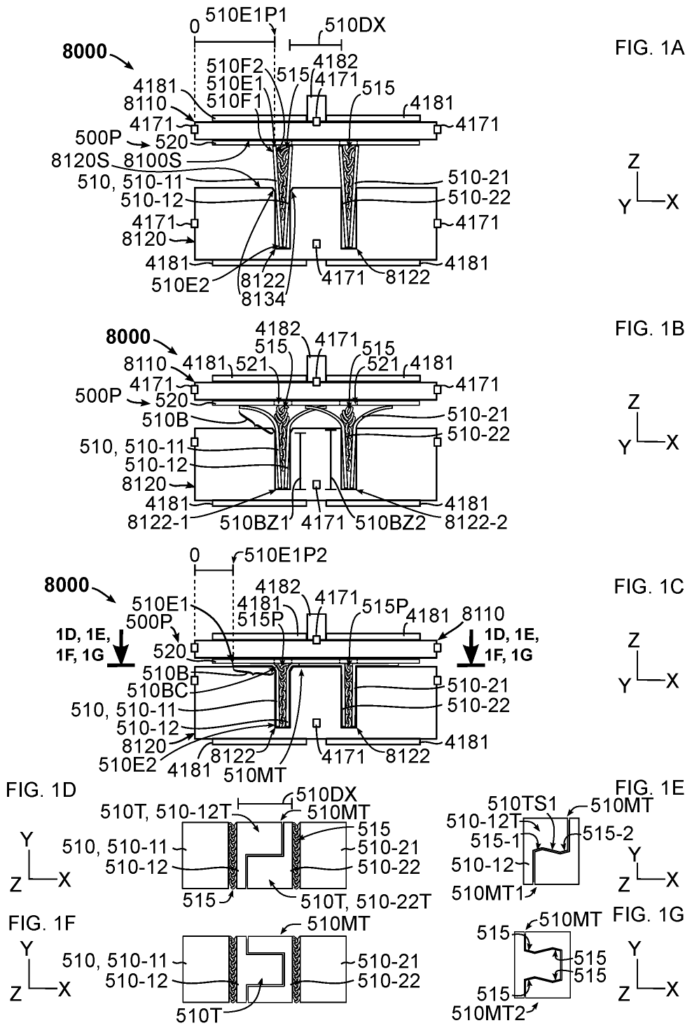

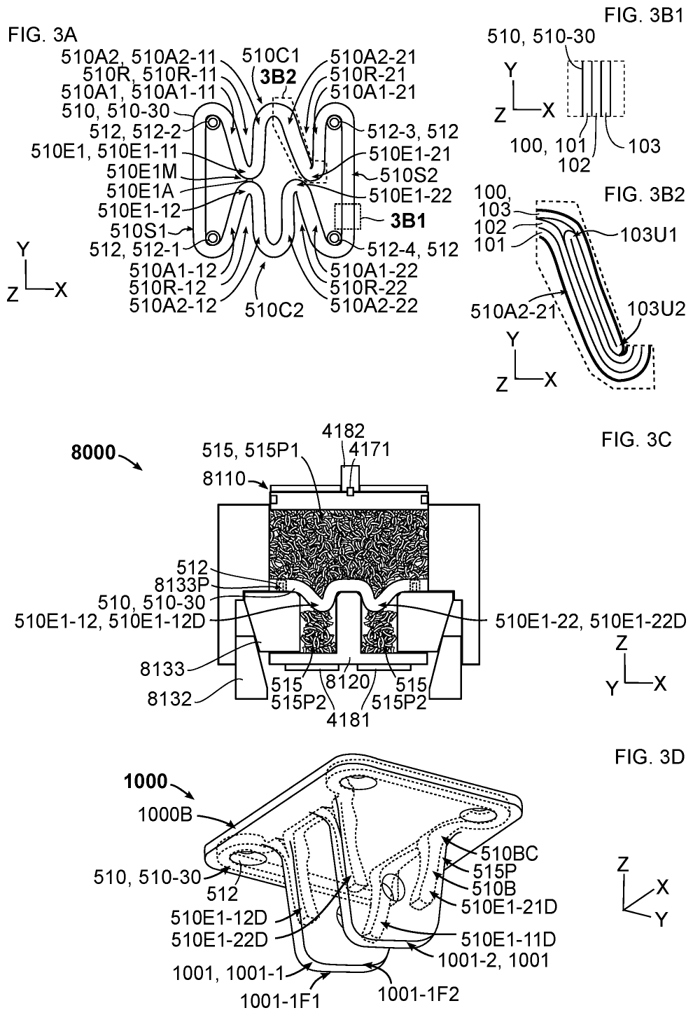

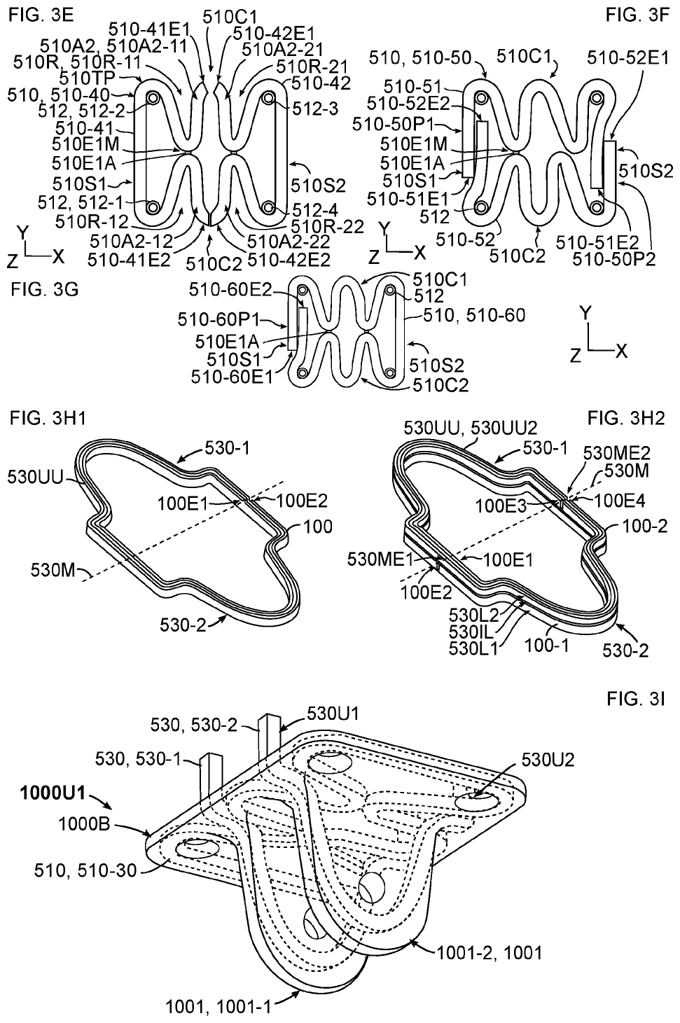

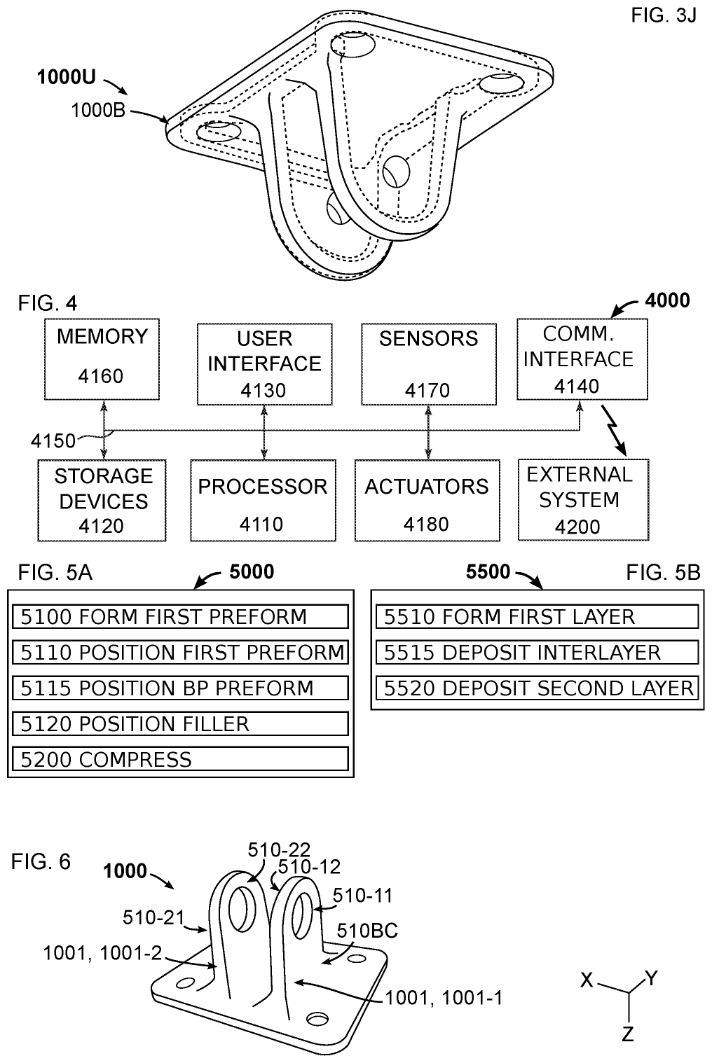

FIG. 5A is a block diagram for a method 5000 for forming a molded device 1000 (FIGS. 3D, 6) comprising an angle plate 1001, 1001-1, 1001-2. For example, the method comprises positioning 5110 in a mold 8000 one or more first preforms 510. In this disclosure, the word positioning encompasses one or more positioning methods, for example: manual positioning; sliding into position; pressing; dropping; placing or adjusting in position using one or more of a magnetic, an electrostatic, a vacuum, and a mechanical chuck; and positioning using a pick-and-place robot, for example comprising one or more robotic manipulators. For example, the first preform comprises a free first end 510E1 (FIG. 1A). For example, the first preform comprises a first thermoplastic material and a plurality of fibers. For example, the fibers comprise elongated fibers, for example one or more of continuous fibers and discontinuous fibers. For example, the fibers are comprised in one or more filaments, for example in one or more tows or rovings 100, 101, 102, 103 (FIG. 3B2). For example, the filament comprises one or more of: a plurality of continuous fibers, a plurality of discontinuous fibers, and a plurality of chopped fibers. For example, a filament comprises one or more of a tow, a roving, a tape, a tape comprising unidirectionally-aligned fibers, a commingled yarn, or a combination thereof. For example the combination is in one or more of: i) a parallel arrangement; and ii) a sequential arrangement along the longitudinal direction of the filament. For example, the filament comprises one or more thermoplastic resins. For example, the filament is preimpregnated with one or more thermoplastic resins. For a further example, the filament is impregnated with one or more thermoplastic resins within 10 minutes prior to or upon deposition of the filament onto a substrate.

For example, a filament comprising a plurality of discontinuous fibers comprises one or more sets of discontinuous fibers arranged as a plurality of parallel fibers. For example, the fibers in a filament comprising discontinuous fibers have a uniform length. For example, the discontinuous fibers have a length comprised in a range from 2 mm to 20 mm, for example from 2 mm to 10 mm, for example from 3 mm to 8 mm, for example from 3 mm to 6 mm. For example, the length-to-diameter ratio of a discontinuous fiber is in a range from 500 to 1500, for example from 600 to 1200. For example, a fiber having a length that is greater than that of a discontinuous fiber is a continuous fiber. For example, a fiber having a length that is less than that of a discontinuous fiber is a chopped fiber. For example, the discontinuous fibers are arranged parallel to the longitudinal direction of the filament. For example, at least 50%, for example more than 75%, for example more than 90%, for example more than 95% of the fibers are parallel to the longitudinal direction of the filament, for example within 15° of the longitudinal direction of the filament, for example within 10°, for example within 5°.

For example, a filament comprises one or more fiber materials, for example selected from one or more of: a carbon fiber, a glass fiber, an aramid fiber, a basalt fiber, a metal fiber, and a natural fiber. For example, a natural fiber comprises fiber extracted from one or more of: a sisal, a flax, a ramie, a cotton, a banana, and a hemp. For example, a set of continuous fibers or a set of discontinuous fibers comprises fibers of one or more of the fiber materials.

For example, a thermoplastic resin comprises one or more of: a polyaryletherketone (PAEK), a polyether ether ketone (PEEK), a polyetherketoneketone (PEKK), a polyetherimide (PEI), an acrylonitrile butadiene styrene (ABS), a nylon, a polybutylene terephthalate (PBT), a polycarbonate (PC), a polycarbonate-ABS (PC-ABS), a polyether sulfone (PES), a polyethylene (PE), a polyamide (PA), a polyimide (PI), a polyethylene terephthalate (PET), a polyphenylene sulfide (PPS), a polyphenylsulfone (PPSU), a polyphosphoric acid (PPA), a polypropylene (PP), a polysulfone (PSU), a polyurethane (PU), and a polyvinyl chloride (PVC).

For example, the method 5000 comprises positioning 5115 in the mold 8000 one or more baseplate preforms 520, 522. For example, the baseplate preform comprises one or more materials, for example: a metal, for example a metal sheet; a polymer; an organic material, for example wood or organic fibers; a thermoplastic material; and a material comprising fibers, for example a fiber-reinforced plastic. For example, the baseplate preform comprises a layup, for example a layup of one or more tows 100 and comprising one or more layers deposited onto a surface, for example a plate, for example a flat plate. For example, the baseplate preform 520, 522 is an organosheet. For example, the baseplate preform comprises a first thermoplastic material and a plurality of fibers. For example, the fibers comprise elongated fibers, for example one or more of continuous fibers and discontinuous fibers.

For example, the baseplate preform, for example a top baseplate preform 520 comprises one or more baseplate orifices 521. For example, the baseplate orifices 521 are have an aperture having a cross-section width that is at least that of one or more of the granulates, pellets, and rods, for example greater than 1 mm, for example greater than 3 mm. for example from 1 mm to 20 mm. For example, one or more of the baseplate orifices 521 is configured to be positioned over one or more wells 8122, 8122-1, 8122-2 of the mold 8000 upon positioning of the baseplate preform inside the mold. A method for positioning filler 5120 inside the mold comprises injecting or dropping one or more of the granulates, pellets, and rods through the baseplate orifices 521. For example, the wells 8122, 8122-1, 8122-2 of the mold 8000 comprise a chamfer 8134, for example a rounded or beveled chamfer at their entry, for example where the well meets a surface 8120S of a second mold component 8120 facing a first mold component 8110. For example, one or more bottom baseplate preform 522 comprise openings configured for passing one or more of the first preforms 510-11, 510-12, 510-21, 510-22.

For example, the first preforms 510, 510-11, 510-12, 510-21, 510-22 and the baseplate preform 520 form a preform assembly 520P. For example, the preform assembly 520P is formed prior to insertion into the mold. For example, forming the preform assembly 520P comprises forming an adhesive bonding between two or more preform components 520, 510, 510-11, 510-12, 510-21, 510-22. For example, the step of positioning 5110 the first preform into the mold 8000 comprises positioning the preform assembly 520P into the mold 8000.

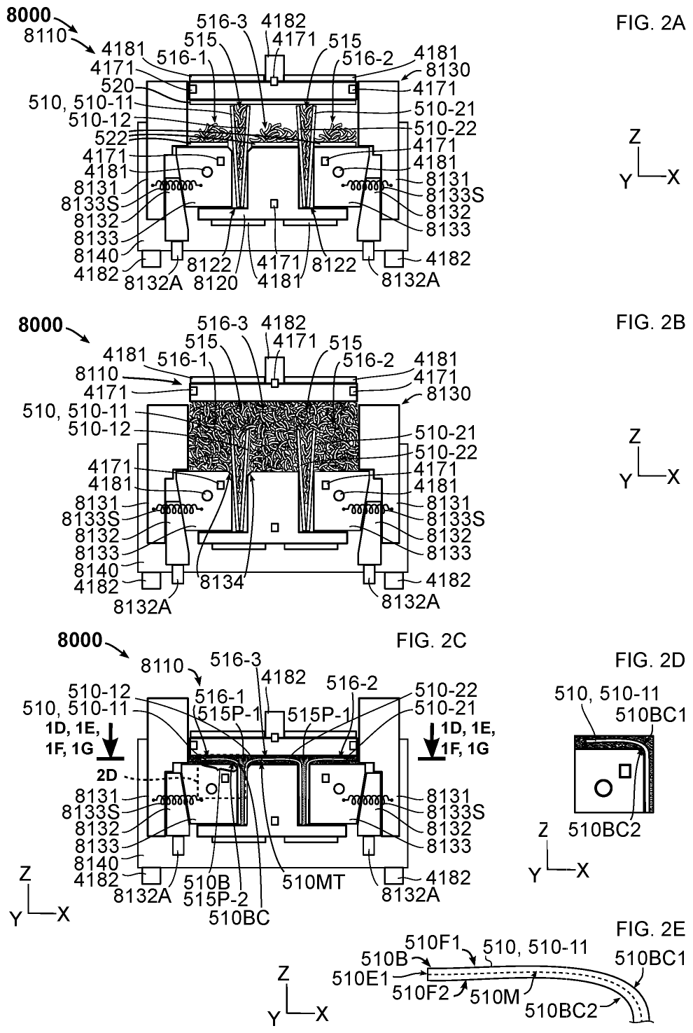

For example, the method 5000 comprises positioning 5120 in the mold one or more fillers 515, 516-1, 516-2, 516-3 (FIGS. 1A, 2A) comprising a second thermoplastic material. For example, the method comprises compressing 5200, for example by translating at least a first surface 8100S of the mold 8000 in at least a −Z-direction, the free first end 510E1 of one or more of the first preforms 510 from a first position 510E1P1 of the first end to a second position 510E1P2 (FIG. 1C) of the first end. For example, during at least a portion of the duration of the compressing, the free first end 510E1 is inclined towards the first surface 8100S of the mold 8000. For example, the compressing 5200 forms a buckling portion 510B in the first preform from a buckling reference elevation 510BZ1, 510BZ2 (FIG. 1B). For example, the compressing forms a padding 515P, 515P-1, 515P-2 (FIGS. 1C, 2C) from at least a portion of the filler positioned against a curved portion 510BC (FIG. 1C) of the buckling 510B.

For example, the first preform 510 comprises a plate. For example, the plate comprises elongate fibers, for example one or more of continuous and discontinuous fibers. For example, a cross-section in the Z-X plane of the first preform 510 is a slender body inclined towards the first surface 8100S of the mold 8000. For example, the slender body has an aspect ratio in the direction of inclination of at least 3:1.

For example, the positioning 5110 of the one or more first preforms 510 is in one or more wells 8122, 8122-1, 8122-2 of the mold 8000. For example, during the positioning 5110 the angle of the free first end 510E1 with respect to the Z-direction is comprised in a range from 0.1° to 80°.

For example, during the positioning 5110 one or more of the one or more fillers 515, 516-1, 516-2, 516-3 is at a temperature that is lower than the glass transition temperature of the second thermoplastic material.

For example, the padding 515P-1, 515P-2 (FIG. 2C) is positioned against one or more of a concave portion 510BC2 and a convex portion 510BC1 (FIG. 2D) of the curved portion 510BC. For example, the padding 515P-2 is positioned against at least a concave portion 510BC2 of the curved portion 510BC.

For example, the mid-line 510M (FIG. 2E) along the longitudinal direction of the cross-section in the Z-X plane of the buckling portion 510B has a continuous first derivative. For example, the first preform 510 comprises a plate having a first face 510F1 and a second face 510F2 and, during the compressing 5200, one or more of the first face and the second face of the buckling portion against one or more of the paddings 515P, 515P-1, 515P-2 has a continuous first derivative.

For example, at the second position 510E1P2, the free first end 510E1 of the preform has a tangent that is orthogonal to an opposite second end 510E2 of the preform.

For example, during at least a portion of the duration of the compressing 5200, the second position 510E1P2 is at the end position of the free first end 510E1 at the end of the compressing 5200. For example, during at least a portion of the duration of the compressing 5200, the free first end 510E1 is at a temperature that is greater than or equal to the glass transition temperature of the second thermoplastic material.

For example, during at least a portion of the duration of the positioning, one or more of the second thermoplastic materials have the form of one or more of: a plurality of granulates; a plurality of chips; a plurality of pellets; and a plurality of rods. For example, the second thermoplastic material comprises one or more fibers. For example, the one or more fibers comprise one or more of: a carbon fiber; a glass fiber; an aramid fiber; and an organic fiber.

For example, the first thermoplastic material comprises one or more of: a carbon fiber; a glass fiber; an aramid fiber; and an organic fiber. For example, the first preform 510 comprises one or more organosheets. For example, an organosheet is a sheet comprising one or more fiber fabrics, for example arranged in a stack comprising a plurality of plies, and one or more thermoplastic polymers. For example, the thermoplastic polymer impregnates one or more of the fiber fabrics. For example, the fiber fabrics comprise one or more of the fiber materials. For example, one or more of the fabrics comprises one or more of: a woven tow fabric; a fiber mat, for example comprising randomly oriented fibers, for example one or more of elongate fibers, for example comprising one or more of continuous fibers and discontinuous fibers, and chopped fibers; and a sheet comprising aligned discontinuous fibers, for example having a uniform fiber length.

For example, a preform, for example an organosheet in a preform, comprises one or more electrically-conductive components, for example to confer so-called lightning or electrical arcing protection, for example one or more of: a conductive mesh, for example comprising a metal; a conductive filler, for example comprising nanotubes, for example carbon nanotubes; a foil, for example a metallic foil; and a conductive coating, for example comprising one or more of a metal, a metal oxide, and carbon nanotubes. For example, an organosheet has a thickness in a range from 0.1 mm to 20 mm, for example from 0.5 mm to 10 mm, for example from 0.7 mm to 8 mm. For example, the organosheet comprises one or more layers entirely comprising unidirectionally-arranged fibers. For example, the organosheet comprises one or more layers comprising tows arranged, for example woven, at a plurality of angles, for example 90°, for example 45°, for example in one or more weaves, for example a plain weave, a twill weave, and a harness satin weave.

For example, the organosheet has a fiber volume content in a range from 3% to 80%, for example from 40% to 75%, for example from 50% to 70%, for example from 55% to 65%, for example of 60%. For example, the organosheet has a polymer, for example a thermoplastic, and a polymer volume content in a range from 20% to 97%, for example from 30% to 60%, for example from 35% to 45%, for example of 40%. For example, the melt temperature of the thermoplastic comprised in the organosheet is in a range from 60° C. to 4100° C., for example from 100° C. to 2000° C., for example from 200° C. to 500° C., for example from 280° C. to 330° C., for example from 300° C. to 310° C., for example 305° C.

For example, one or more portions of the organosheet is deformed at a temperature comprised in a range from 150° C. below melt temperature to 50° C. above melt temperature, for example from 145° C. below melt temperature to 130° C. below melt temperature. For example, one or more portions of the organosheet is deformed at a temperature comprised in a range from, with respect to 0° C., 40% to 120% of melt temperature, for example from 50% to 100% of melt temperature, for example from 52% to 58% of melt temperature of the organosheet. For example, the melt temperature of the polymer comprised in the organosheet is lower than the melt temperature of the polymer comprised in the pellets, for example lower in a range from 3° C. to 200° C., for example from 10° C. to 50° C., for example from 20° C. to 40° C., for example from 25° C. to 35° C.

For example, the first preform 510 comprises one or more layers comprising one or more tows comprising a plurality of elongated fibers.

For example, the method comprises forming 5100 the first preform by depositing one or more tows comprising a plurality of elongated fibers. For example, the tow comprises the first thermoplastic material. For example, the tow comprises a tape comprising a plurality of unidirectional elongated fibers. For example, the tow is folded along its longitudinal axis, for example along the direction of the elongated fibers.

For example, the positioning 5110 comprises positioning a first first preform 510-11 with a first inclination on a first side with respect to the Z-direction and positioning a second first preform 510-12 with a second inclination on a second opposite side with respect to the Z-direction wherein the first inclination diverges from the second inclination in the Z-direction.

For example, the positioning 5110 comprises positioning a second first preform 510-12 with a second inclination and positioning a third first preform 510-22 with a third inclination at a separation distance 510DX in the X-direction orthogonal to the Z-direction, wherein the separation distance is measured at one or more buckling reference elevations 510BZ1, 510BZ2.

For example, the second first preform 510-12 is positioned in a first well 8122-1 and the third first preform 510-22 is positioned in a second well 8122-2. For example, the method comprises positioning a first first preform 510-11 in the first well 8122-1 and a fourth first preform 510-21 in the second well 8122-2.

For example, one or more of the first first preforms 510-11 diverge from the second first preform 510-12 in the Z-direction and the third first preform 510-22 diverges from the fourth first preform 510-21 in the Z-direction.

For example, one or more of: the volume comprised between the first first preform 510-11 and the second first preform 510-12; and the volume comprised between the third first preform 510-22 and the fourth first preform 510-21, is filled with the one or more fillers 515. For example, the filler comprises one or more bulk molding compounds, for example comprising one or more chips, for example comprising one or more fibers, for example chopped fibers, for example fibers recycled or collected from another fiber-comprising product.

For example, the method comprises compressing the one or more fillers 515 along one or more of the Z-axis and the X-axis.

For example, the compressing along the X-axis comprises actuating one or more actuators 8132A. For example, the compressing along the X-axis comprises translating one or more wedges 8132 against one or more clamps 8133.

For example, the positioning 5110 comprises positioning the second first preform 510-12 with the second inclination on a second side with respect to the Z-direction and positioning the third first preform 510-22 with the third inclination on a first opposite side with respect to the Z-direction wherein the second inclination converges towards the third inclination in the Z-direction.

For example, one or more of the one or more first preforms 510 comprise one or more tongues 510T, 510-12T, 510-22T (FIGS. 1D, 1E). For example, the one or more tongues 510T, 510-12T, 510-22T comprise 3 sides of a rectangle. For example, the one or more tongues 510T, 510-12T, 510-22T comprise 3 sides of a modified rectangle comprising, on at least one of the outwardly extending side 510TS1 of the tongue, one or more first indenting angled bevels 515-1 at the base of the tongue and one or more second angled bevels 515-2 at the tip of the tongue. For example, the angle of the first indenting angled bevel 515-1 is equal to the angle of the second angled bevel 515-2. For example, the contour of the at least one of the outwardly extending side 510TS1 of the tongue is approximated by one or more S-shaped curve that is symmetrical about the center of the S. For example, at least a portion of the tongue 510T, 510-12T, 510-22T is comprised in the buckling portion 510B.

For example, during at least a portion of the duration of the compressing, one or more of the tongues 510T, 510-12T, 510-22T extends towards the first surface 8100S of the mold 8000.

For example, a second first preform 510-12 comprises one or more second tongues 510-12T having a second inclination on a second side with respect to the Z-direction and a third first preform 510-22 comprises one or more third tongues 510-22T having a third inclination on a first opposite side with respect to the Z-direction wherein the second inclination converges towards the third inclination in the Z-direction.

For example, during the compressing 5200, the one or more second tongues 510-12T and the one or more third tongues 510-22T form one or more of an interlacing and alternating mortise and tenon arrangement 510MT (FIGS. 1D, 1E, 1F, 1G). For example, the alternating mortise and tenon arrangement 510MT comprises one or more beveled dovetail mortise and tenon arrangements 510MT1, 510MT2 (FIGS. 1E, 1G).

FIG. 6 presents a perspective view of a molded device 1000 comprising an angle plate 1001. For example, the molded device shown in FIG. 6 comprises 2 angle plates 1001, 1001-1, 1001-2 for example formed as 2 prongs of a clevis or pin bracket. For example, the angle of a prong with respect to a base plane, for example the X-Y plane, is comprised in a range from 5° to 90°, for example from 10° to 90°, for example from 20° to 90°, for example from 30° to 90°, for example from 45° to 90°, for example from 60° to 90°. For example, the molded device comprises a plurality of angle plates, for example forming one or more clevises or pin brackets comprising a plurality of prongs. For example, the device comprises one or more first preforms 510. For example, the first preform comprises a free first end 510E1. For example, the first preform comprises a first thermoplastic material and a plurality of elongated fibers, for example having a length greater than 10 mm, for example greater than 30 mm, for example greater than 50 mm, for example resulting from the deposition of a continuous filament, for example comprising a plurality of continuous fibers. For example, the device comprises one or more fillers 515, 516-1, 516-2, 516-3 comprising a second thermoplastic material. For example, the angle plate comprises:—a buckling portion 510B in the first preform from a buckling reference elevation 510BZ1, 510BZ2; and—a padding 515P, 515P-1, 515P-2 from at least a portion of the filler positioned against a curved portion 510BC of the buckling 510B.

FIGS. 1A, 1B, 1C, 2A, 2B, 2C, 2D present side views or Z-X plane cross-sections of a mold system 8000 for forming a molded device 1000 comprising an angle plate 1001, comprising: a first mold component 8110, for example a piston, comprising at least a first surface 8100S internal to the mold; a second mold component 8120 comprising one or more wells 8122, 8122-1, 8122-2; and one or more actuators 4180,, for example a compression actuator 4182, for example linear motion actuators, for example configured for imparting motion in the Z-direction, connected to one or more of the first mold component and the second mold component. For example, one or more of the first mold components and the second mold components comprise or are configured to slide against a guiding rail 8131 oriented along a Z-axis. For example, the one or more wells comprise one or more clamps 8133 in sliding contact with a guide rail oriented along an X-axis. For example, one or more of the clamps is mechanically connected to the guiding rail 8131, for example by a tensioning device 8133S, for example a spring, for example configured to contact the clamp 8133, for example by tensioning of the tensioning device 8133S, against the wedge 8132. For example, the mold system 8000 comprises one or more temperature adjusting actuators 4181, for example comprising one or more heating devices. For example, the compression molding system 8000 comprises one or more temperature sensors 4171, for example connected to one or more of the first mold component 8110 and the second mold component 8120. For example, one or more components of the mold system 8000, for example the wedges 8132, the clamps 8133, the second mold component 8120, and the guiding rails 8131, are supported, for example partly enclosed, by a chassis 8140.

FIG. 3A is a top view of a first preform 510, 510-30 having a crenelated contour. For example, the crenelated contour comprises one or more crenellations 510R, for example a first crenellation 510R-11, a second crenellation 510R-12, a third crenellation 510R-21, and a fourth crenellation 510R-22. For example, a first set of crenellations, for example comprising the first crenellation 510R-11 and the third crenellation 510R-21, comprises one or more crenellations on a first side of the first preform 510. For example, a second set of crenellations, for example comprising the second crenellation 510R-12 and the fourth crenellation 510R-22, comprises one or more crenellations on a second side of the first preform 510. For example, the first side is opposite the second side.

For example, FIG. 3B1 shows a top view of one or more tows 100, 101, 102, 103 comprised in a first preform 510, for example along one or more of the contours of the first preform. For example, the tows are arranged concentrically, for example with respect to a point within the outline of the first preform, to follow at least a portion of the contour of the first preform 510, for example in the X-Y plane. For example, the tows are arranged to follow the contour of the first preform 510 in a spiral path, whether continuous or segmented, for example in the X-Y plane.

For example, the first preform 510 forms a closed loop. For example, the first preform 510 comprises one or more closed loops. For example, one or more of the loops comprises one or more tows arranged as a loop, for example as one or more concentric loops, for another example as one or more spiral loops, or a combination thereof.

For example, the first preform 510, 510-30 comprises a stack of one or more layers comprising one or more tows. For example, the layers form a stack in the Z-direction. For example, one or more of the layers of the stack comprises one or more tows arranged to follow one or more of the contours of the first preform. For example, one or more of the tows 100, 103 parallel to one or more of the contours of the first preform in a first direction comprises a U-turn 103U1, 103U2 and continues along a track that is parallel to one or more of the contours in a second direction, for example that is opposite to the first direction (FIG. 3B2). For example, a layer comprises a first spiral path spiraling inwards in a first direction, for example in a clockwise direction. For example, a layer comprises a second spiral path spiraling inwards in a second direction, for example in an anti-clockwise direction. For example, the first spiral is on a first layer and the second spiral is on a second layer of a stack of layers.

For example, the first preform comprises one or more inserts 512. For example in FIG. 3A, the inserts are numbered clockwise as first 512-1, second 512-2, third 512-3, and fourth 512-4 inserts. A configuration example with more or fewer than 4 inserts is also possible. For example, the insert is positioned against one or more tows 101, 102, 103 following at least a portion of the contour of the first preform 510. For example, the insert is made of a material having a melt temperature that is greater than that of an adhesive, for example a thermoplastic adhesive, impregnating the one or more tows. For example, the one or more tows comprise one or more of the thermoplastic resins. For example, a thermoplastic further comprises a filler, for example a microsphere filler. For another example, the insert is made of a metal, for example a metal comprising one or more coating layers, for example resulting from one or more of an anodizing and a coating process. For example, the coating layer one or more of prevents a chemical reaction, for example galvanic corrosion, and increases adhesion between the first preform and the insert. For example, describing clockwise, the first preform has one or more of: a first straight portion 510S1 from the first insert 512-1 to the second insert 512-2; a first crenelated portion 510C1 from the second insert 512-2 to the third insert 512-3; a second straight portion 510S2 from the third insert 512-3 to the fourth insert 512-4; and a second crenelated portion 510C2 from the fourth insert 512-4 to the first insert 512-1.

FIG. 3C is an X-Z plane cross-section of a mold system 8000 with one or more first preforms 510 having a crenelated contour comprising a plurality, for example 4, crenellations 510R. For example, one or more parts of the mold 8000. for example one or more of a static or a mobile part of the mold, for example the clamp 8133, comprises one or more anchoring points, for example a centering pin 8133P or an aligning hole (not shown), for example configured for anchoring one or more portions of the first preform 510. For example, the anchoring point one or more of contacts, is inserted into, and is inserted by the one or more inserts 512. For example, the anchoring point contacts one or more of fiber and adhesive of the preform 510. For example, the anchoring point contacts one or more tows 100, 101 configured to follow the contour, for example in the X-Y plane, of at least a portion of the anchoring point. For example, in a method 5000 for forming an angle plate 1000 the one or more anchoring points are used for one or more of maintaining, adjusting, and guiding one or more portions of the first preform 510. For example, the adjusting comprises moving one or more of the anchoring points, for example by moving one or more second mold components 8133 of the mold 8000, for example during motion of one or more first mold components, for example the piston 8110.

For example, one or more crenellations 510R, 510R-11, 510R-12, 510R-21, 510R-22 comprise, for example, a first leg 510A1, 510A1-11, 510A1-12, 510A1-21, 510A1-21 of a crenellation and a second leg 510A2, 510A2-11, 510A2-12, 510A2-21, 510A2-21 of a crenellation. For example, the first leg of a crenellation and the second leg of a crenellation form an angle with respect to each other. In another example (not shown), the first leg of a crenellation and the second leg of a crenellation are parallel to each other. For example, the extremity of a first crenellation faces the extremity of a second crenellation mirror point 510E1M. For example, a first crenellation 510R-11 joins a second crenellation 510R-12, for example with an adhesive portion 510E1A. For example, the adhesive is adhesive contained in a portion of tow, for example a portion of prepreg tow, comprised in the crenellation. In another example, the adhesive is added material. In yet another example, the extremity of a first crenellation faces the extremity of a second crenellation without contact. Still in another example, a first crenellation 510R-21 and a second crenellation 510R-22 form a point symmetrical arrangement.

For example, in a method 5000 (FIG. 5A) to form a device comprising one or more angle plates, for example the clevis or pin bracket 1000 shown in FIG. 3D, one or more first preforms 510 are fabricated 5110, for example using an additive manufacturing system comprising a head configured for depositing a filament or tape comprising fibers, for example a continuous tow 100. For example, the first preform 510 is manufactured as a layup, for example a layup of one or more tows 100 and comprising one or more layers deposited onto a surface, for example a plate, for example a flat plate. For example, one or more first preforms 510 are positioned 5110 in a mold, for example by anchoring to one or more anchoring points, for example one or more centering pins 8133P. For example, the positioning further comprises placing one or more inserts 512. For example, there are one or more ways to integrate the inserts 512 into a first preform 510: i) by forming the first preform 510 in contact with the insert 512; ii) by pressing the insert 512, for example with heating of one or more of the insert 512 and the first preform 510, into the first preform 510, for example against a contour of the first preform 510; and iii) by placing one or more inserts 512 onto one or more centering pins 8133P and placing the one or more first preforms into the mold.

FIG. 3C shows, for example, a first preform 510, 510-30, with the crenellation extremities 510E1-12, 510E1-22 being deformed, for example deflected in the −Z-direction, for example as illustrated by an intermediate position 510E1-12D, 510E1-22D. For example, the deflection is caused by one or more of: adding or positioning 5120 a filler 515 into the mold; heating the mold; and displacing one or more components 8110, 8133 of the mold. For example, FIG. 3C illustrates an intermediate stage of the compression and flow of the filler 515 and the deflection of the crenellation extremities. In FIG. 3C, a first portion 515P1 of the filler 515 is on a first side (for example above, in the Z-direction) of the one or more first preforms 510 and a second portion 515P2 is on a second side (for example below, in the −Z-direction) of the one or more first preforms 510. For example, the passing of filler material from the first side to the second side is the result of one or more of gravity and pressure induced by the displacement of the one or more components 8110, 8133 of the mold, for example the piston 8110. For example, one or more of the crenellations and the legs limit one or more of the number of filler granules and the volume of filler material passing from the first side to the second side, for example as a function of temperature. For example, a method for regulating the transfer of filler material from the first side to the second side comprises adjusting or controlling one or more of the temperature, the temperature adjusting actuators 4181, the pressure, and the movable components 8110, 8133 of the mold at one or more locations within the mold, for example at a location on the first side and a location on the second side. For example, a method comprising adjusting one or more of the temperature, the pressure, and the motion of parts of the mold provides a method for one or more of: i) transferring a filler material from the first side to the second side; ii) controllably deflecting or buckling one or more contours of the first preform, for example one or more crenellations or legs; and iii) adjusting the forming of a padding 515P from at least a portion of the filler positioned against a curved portion 510BC of the deflected or buckled 510B portion of the first preform.

FIG. 3D is a perspective view of a molded device 1000 comprising one or more angle plates, for example a clevis or pin bracket, formed using a first preform 510 comprising a contour comprising one or more crenellations. In FIG. 3D, the crenellation extremities 510E1-11, 510E1-12, 510E1-21, 510E1-22 are depicted in a folded or buckled configuration 510E1-11D, 510E1-12D, 510E1-21D, 510E1-22D after having undergone deformation in one or more directions. For example, a first deformation is undergone in the −Z-direction, for example under one or more of gravity, for example upon addition of heat to the mold, and pressure by the piston 8110. For example, one or more of the crenellation extremities is one or more of entrained, for example by the second thermoplastic material, and pressed into the cavities of the one or more wells 8122, 8122-1, 8122-2 of the mold 8000. For example, a second deformation is undergone along the X-axis, for example caused by one or more of mold geometry and motion of one or more mold components 8133. For example, the second deformation causes the first leg 510A1 and the second leg 510A2 of a crenellation to form or increase a contact surface with each other and, for example, to form a bonding with each other along at least a portion of the length of the legs. For example, a method for investigating the bonding comprises using one or more of a destructive method, for example sectioning, and a non-destructive method, for example using an X-ray computer tomography (CT scanning) method. For example, a third deformation is undergone along the Y-axis, for example caused by one or more of internal mold surface geometry and the presence, for example the flow, of filler material, for example forming a padding 515P, for example between one or more of the crenellations, the legs of the crenellations, and the internal mold surface. For example, a combination of one or more of the first, the second, and the third deformations is present and includes, for example, curving, rotation, and twisting of one or more of the legs and the crenellations around one or more axes.

FIG. 3E is a top view of, for example, a first preform 510, 510-40 having a crenelated contour, the first preform being split into, for example, a first preform component 510-41 and a second preform component 510-42, each having endings 510-41E1, 510-41E2, 510-42E1, 510-42E2 in crenelated portions 510C1, 510C2 of the first preform. For example, starting from a first end 510-41E1 of the first preform component 510-41, the first preform component 510-41 comprises a first crenellation 510R-11, for example comprising a first leg 510A2-11, in a first crenelated portion 510C1, and a second crenellation 510R-12, for example comprising a second leg 510A2-12 in a second crenelated portion 510C2, ending at a second end 510-41E2. For example, the first preform component 510-41 comprises a straight portion 510S1 joining the first crenellation 510R-11 to the second crenellation 510R-12. As a further example, the first crenellation 510R-11 is joined to the second crenellation 510R-12 by an adhesive portion 510E1A.

For example, the second preform component 510-42 is configured as the first preform component 510-41 and comprises, starting from a first end 510-42E1, a first crenellation 510R-21, for example comprising a first leg 510A2-21, in a first crenelated portion 510C1, and a second crenellation 510R-22, for example comprising a second leg 510A2-22 in a second crenelated portion 510C2, ending at a second end 510-42E2. For example, the second preform component 510-42 comprises a straight portion 510S2 joining the first crenellation 510R-21 to the second crenellation 510R-22. For example, the second preform component 510-42 is configured as a mirror of the first preform component 510-41, for example symmetrically reflected with respect to an axis parallel to the Y-axis.

For example, a preform component 510-41, 510-42 comprises one or more inserts 512. For example, the first preform component 510-41 comprises a first insert 512-1 and a second insert 512-2. For example, the second preform component 510-42 comprises a third insert 512-3 and a fourth insert 512-4. For example, the straight portion 510S1 extends from the second insert 512-2 to the first insert 512-1. For example, the straight portion 510S2 extends from the third insert 512-3 to the fourth insert 512-4. For example, one or more of the preform components 510-41, 510-42 follow a turning path 510TP around at least a portion of the periphery of one or more of the inserts 512. For example, a turning path 510TP forms an arc in a range from 10° to 350°, for example from 30° to 180°, for example from 60° to 160°. For example, a method to form a first preform 510 or a preform component 510-41, 510-42 comprising an insert 512 comprises forming a turning path 512TP, for example a turning path having an arc extending over at least 180°, and snap-fitting the insert into the concave recess formed by the turning path. For example, upon insertion into a molding system 8000, one or more of the endings 510-41E1, 510-41E2 of the first preform component 510-41 face the endings 510-42E1, 510-42E2 of the second preform component 510-42. In a further example, one or more of the endings 510-41E2 of the first preform component 510-41 contact the endings 510-42E2 of the second preform component 510-42. In an alternative method, for example, one or more of the preform components 510-41, 510-42 is inserted into the molding system 8000 by snap-fitting against one or more inserts 512. For example, a preform component is inserted by snap-fitting against two or more inserts, for example for the first preform component 510-41 against the first insert 512-1 and the second insert 512-2. For example, the preform component fastens itself by snap-fitting via elastic deformation, for example widening of the distance separating a first ending 510-41E1, 510-42E1 from a second ending 510-41E2, 510-42E2, of the preform component.

FIG. 3F is a top view of, for example, a first preform 510, 510-50 having a crenelated contour, the first preform being split into, for example, a first preform component 510-51 and a second preform component 510-52, each having endings 510-51E1, 510-51E2, 510-52E1, 510-52E2 in straight portions 510S1, 510S2 of the first preform. For example, starting from a first ending 510-51E1 of the first preform component 510-51, the first preform component 510-51 comprises a straight portion 510S1 continued by a first crenelated portion 510C1 until a second ending 510-51E2. For example, starting from a first ending 510-52E1 of the second preform component 510-52, the second preform component 510-52 comprises a straight portion 510S2 continued by a second crenelated portion 510C2 until a second ending 510-52E2. For example, the second ending 510-52E2 of the second preform component 510-52 runs parallel to the straight portion 510S1 of the first preform component 510-51, for example in a first parallel portion 510-50P1. For example, the first ending 510-51E2 of the first preform component 510-51 runs parallel to the straight portion 510S2 of the second preform component 510-52, for example in a second parallel portion 510-50P2. For example, the second preform component 510-52 is configured as a mirror of the first preform component 510-51, for example symmetrically reflected with respect to an axis parallel to the X-axis.

For example, the first preform component 510-51 and the second preform component 510-52 are connected to each other by snap-fitting, for example upon insertion into the molding system 8000. For a further example, one or more of the first and the second preform components are fastened against one or more inserts 512, for example upon insertion into the molding system 8000. For example, the first and the second preform components are both connected to each other and to one or more parts positioned in the mold, for example the inserts 512, by snap-fitting, for example synchronously.

FIG. 3G is a top view of, for example, a first preform 510, 510-60 having one or more crenelated portions 510C1, 510C2. For example, starting from a first ending 510-60E1, the first preform 510-60, which in this example forms a single preform component, comprises a first straight portion 510S1 that continues into a first crenelated portion 510C1 that itself continues into a second straight portion 510S2 that continues into a second crenelated portion 510C2. For example, the second crenelated portion 510C2 forms one or more crenellations and extends into a second ending 510-60E2. For example, the second ending 510-60E2 runs parallel to the straight portion 510S1 in a first parallel portion 510-60P1. For example, the second ending 510-60E2 runs parallel to the first ending 510-60E1 and forms a sliding snap fitting upon insertion of the first preform 510-60 into the molding system 8000, for example by elastic deformation against one or more inserts 512.

For example a first preform 510, 510-40, 510-50, 510-60 comprises one or more filaments, for example one or more tapes, as described for the first preform 510-30 of FIG. 3A. For another example a first preform 510, 510-40, 510-50, 510-60 comprises one or more profiled rods. For example, a profiled rod is formed by extrusion of a material comprising a plurality of non-aligned fibers and one or more resins. For example, a profiled rod 1055 is formed by pultrusion of a material comprising a plurality of co-aligned continuous fibers and one or more resins. For example, a resin comprised in a profiled rod is a thermoplastic resin. For example, a profiled rod comprises a coating, for example comprising a thermoplastic resin, on its exterior surface. For example, a profiled rod comprises from 5 fibers to 10 million fibers, for example from 5 to 1 million fibers, for example from 5 to 100000 fibers, for example from 5 to 50000 fibers, for example from 1100 to 40000 fibers, for example from 1100 to 5000 fibers. For example, a profiled rod has one or more of a circular, oval, and rectangular cross-section. Any other cross-section geometry is possible, for example comprising a plurality of straight and rounded contours. For example, each of the preform components 510-41, 510-42, 510-51, 510-52, 510-60 is a profiled rod. In a further example, a preform component comprises a combination of deposited filaments, as presented in the description of FIG. 3A, 3B1, and 3B2, and profiled rods.

For example, a method for forming a device 1000 comprising one or more angle plates, for example comprising one or more clevises or pin brackets, comprises one or more of: i) forming one or more of first preforms 510 comprising one or more crenellations 510R; ii) inserting one or more of the first preforms into a mold of a molding system 8000, for example a compression molding system; iii) adding one or more filler material 515 into the mold; and applying one or more of heat and pressure to the mold, for example controllably, for example to at least a melt temperature of one or more of the filler material and the adhesive comprised in the first preform. For example, one or more of a filler material and an adhesive material is supplied as one or more of chips, pellets, and granules, for example delivered as such or in the form of a paste, an injected material, an overinjected material, or a combination thereof. For example, a pellet has a dimension, for example in width or height, in a range from 0.5 mm to 30 mm, for example from 1 mm to 20 mm, for example from 2 mm to 10 mm. For example, the pellet originates from a recycled material, for example comprising one or more of a thermoplastic and a fiber. For example, the melt temperature one or more of the chips, pellets, and granules is in a range from 63° C. to 4100° C., for example from 100° C. to 2000° C., for example from 200° C. to 500° C., for example from 300° C. to 370° C., for example from 330° C. to 340° C., for example of 335° C.

For example, a method for increasing the strength of an angle plate comprises designing or adjusting an angle of one or more of the legs 510A1, 510A2 of a crenellation 510R with respect to the angle plate 1001-1, 1001-2 where it lodges itself, for example the angle with respect to a face 1001-1F1, 1001-1F2 of the angle plate 1001-1. For example, FIG. 3A shows a first crenellation 510R11 formed or arranged as a right triangle wherein a first leg 510A1-11 is configured as a hypotenuse of the triangle and a second leg 510A1-12 is configured as an adjacent side of the triangle. For example, the angle adjusts itself during the step of molding, for example during insertion into the mold cavity used to form the angle plate. For example, a method for adjusting is a function of the controlling of temperature and fluidity of the filler during the molding, for example during compression molding.

For example, during use of the finished and solidified angle plate 1000, the first leg 510A1-11, for example configured as a hypotenuse, forms a buttress within the angle plate and provides a pathway for the distribution of stresses towards a base plate 1000B of the angle plate 1000. For example, the second leg 510A1-12, for example configured as an adjacent side of the triangle, is used to convey a greater share of stresses along the Z-axis, for example into the base plate 1000B, for example as a result of traction in the Z-direction. For example, the first leg 510A1-11, for example configured as a hypotenuse, is used to convey a greater share of stresses along one or more of the X- and Y-axes, for example as a result of traction in one or more of the X- and Y-directions.

For example, a second leg comprises a greater number of fibers than a first leg (or vice versa). For example, a second leg comprises a greater number of tows than a first leg (or vice versa). For example, a second leg has a cross-section with a greater number of tows than a first leg (or vice versa). For example, a second leg has a layer having a cross-section having a greater number of tows than the same layer in a first leg (or vice versa). For example, as shown in FIG. 3B2, a second leg comprises one or more U-turns 101U1, 101U2 in one or more tows 100, 103. For example, a tow comprises one or more U-turns 101U1, 101U2, for example 2 U-turns. For example, a tow comprises a first U-turn in a first leg and a second U-turn in a second leg. For example, a crenellation comprises one or more tows comprising one or more U-turns. For example, a crenellation comprises a first U-turn in a first leg of the crenellation and a second U-turn in a second leg of the crenellation.

For example, each tow in a plurality of parallel tows comprises one or more U-turns. For example, a method to form a leg, a crenellation, or a portion that deploys during a step of molding, for example compression molding, comprises forming a portion wherein each tow in a plurality of parallel tows comprises one or more U-turns, for example a first U-turn and a second U-turn arranged parallel to each other, for example to form 2 or more parallel S's.

Although this example has focused on a crenellation comprising legs arranged in a right angle, the skilled person will readily adapt the crenellation to another crenellation geometry, for example: an isosceles triangle, any triangle, an inverted U comprising two parallel legs, or a combination thereof. For example, a first preform has a plurality of crenellations comprised between a first anchoring point 512 and a second anchoring point 512.

For example, the angle plate comprises a first portion of continuous fibers, for example comprised in the first preform 510, and a second portion of bulk molding compound, for example comprised in the filler 515. For example the portions are calculated on the basis of one or more of fiber content, weight, and volume. For example, the angle plate comprises a first portion of continuous fibers in a range from 3% to 80%, for example from 10% to 50%, for example from 15% to 25%, of one or more of fiber content, weight, and volume and of bulk molding compound in a range from 20% to 97%, for example from 50% to 90%, for example from 75% to 85%, of one or more of fiber content, weight, and volume.

FIG. 3H1 is a perspective view of a double-U preform 530UU comprising a first U-shaped geometry 530-1 and a second, opposite, U-shaped geometry 530-2. For example, the double-U preform comprises one or more layers of filament 100. For example, the two or more layers are deposited continuously by continuous deposition of a single filament 100 continuing from a first layer to a second layer by overlapping onto the first layer. For example, the double-U preform comprises a filament 100 arranged in a spiral deposition arrangement. For example, one or more of a first end 100E1 and a second end 100E2 of the filament 100 is at the line of symmetry 530M between the first U-shaped geometry 530-1 and the second U-shaped geometry 530-2. For example, a method for separating the first U-shaped geometry 530-1 from the second U-shaped geometry 530-2 comprises cutting the double-U preform 530UU, for example using one or more of a cutter, a guillotine, and cutting pliers, along the line of symmetry 530M.

FIG. 5B is a block diagram for a method 5500 for forming the double-U preform 530UU. For example, the method for forming the double-U preform 530UU comprises starting the deposition of a filament 100 at the first end 100E1, for example at the line of symmetry 530M, and continuing the deposition in a spiral pattern, for example in an outwardly-progressing spiral. For example, with the deposition progressing continuously from a first layer to a second layer, a double-U preform 5300UU comprising an even number of layers has the second end at the internal side of the spiral, for example at the line of symmetry 530M, whereas a double-U preform 5300UU comprising an odd number of layers has the second end at the external side of the spiral, for example at the line of symmetry 530M.

FIG. 3H2 is a perspective view of a double-U preform 530UU2 comprising a plurality of separate layers, for example one or more first layers 530L1 and one or more second layers 530L2. For example, the layers 530L1, 530L2 are bonded to each other by an interlayer 530IL, for example between the first layer and the second layer. For example, one or more first layers 530L1 comprise the first end 100E1 and the second end 100E2 of the filament 100 at a first end 530ME1 of the line of symmetry 530M, For example, one or more second layers 530L2 comprise a first end 100E3 and a second end 100E2 of the filament 100 at a second end 530ME2 of the line of symmetry 530M that is, for example, opposite the first end 530M1 along an external contour of the double-U preform 530UU, 530UU2,

For example, a method 5500 for forming the double-U preform 530UU2 comprising a plurality of separate layers comprises a step 5510 of forming one or more first layers 530L1 by depositing a first filament 100-1 starting with the first end 100E1 of the first filament 100-1 at, for example, the first end 530ME1 of the line of symmetry 530M. For example, the depositing continues, for example as an outward spiral, and ends by cutting the first filament 100-1 upon returning, after depositing one or more turns of filament around the double-U, at the first end 530ME1 of the line of symmetry 530M.

For example, the method for forming the double-U preform 530UU2 comprises a step 5515 of depositing one or more interlayers 530IL. For example, the material composition of an interlayer is different from that of one or more of the first layers and the second layers. For example, the material composition of an interlayer comprises a lower fiber to adhesive ratio than that of one or more of the first layers and the second layers. For example, the interlayer comprises one or more thermoplastic resins. For example, the interlayer is made of one or more thermoplastic resins. For example, depositing the one or more interlayers comprises depositing interlayer material in a spiral pattern that overlaps, for example follows, the path of the filament deposited to form the underlying layer, for example the path of the first filament 100-1 in the first layer 530L1. For another example, depositing the one or more interlayers comprises depositing interlayer material in a spiral pattern that overlaps the edge of an underlying filament arranged in a spiral, for example the outer edge of a filament deposited in an outwardly-progressing spiral, with, for example, one turn fewer of the interlayer material compared to that of the underlying filament.

For example, the method for forming the double-U preform 530UU2 comprises a step 5520 of forming one or more second layers 530L2 by depositing a second filament 100-2 starting with a first end 100E3 of a second filament 100-2 at, for example, the second end 530ME2 of the line of symmetry 530M. For example, the depositing continues, for example as an outward spiral, and ends by cutting the second filament 100-2 upon returning, after depositing one or more turns of the second filament around the double-U, at the second end 530ME2 of the line of symmetry 530M, thereby forming the second end 100E4 of the second filament. For example, the second filament is deposited in the same turning direction as the first filament. For example the first filament and the second filament are deposited clockwise. For example, the second filament is deposited in a turning direction that is opposite that of the first filament. For example the first filament is deposited clockwise and the second filament is deposited counterclockwise. For example, the method for forming the double-U preform 530UU2 comprises the sequence comprising the steps: i) the step of forming one or more first layers 530L1; ii) the step of depositing one or more interlayers 530IL; and iii) the step of forming one or more second layers 530L2.

For example, the cutting uses a blade at a temperature greater than the glass transition temperature of thermoplastic material impregnating the filament 100, for example at a temperature greater or equal than the melt temperature of the thermoplastic material, for example at a temperature in a range from 140° C. to 400° C., for example from 150° C. to 350° C. For example, in the method for cutting the preform 530UU, the preform is brought to a temperature in a range from 140° C. to 340° C., for example from 150° C. to 320° C.

FIG. 3I is a perspective view of a preform arrangement 1000U1 to form a molded device 1000U comprising one or more angle plates comprising one or more U-shaped preforms 530, 530-1, 530-2, for example a clevis or pin bracket, formed using a first preform 510 comprising a contour comprising one or more crenellations. FIG. 3J is a perspective view of a molded device 1000U comprising one or more angle plates comprising one or more U-shaped preforms 530. The preform arrangement 1000U1 comprising one or more U-shaped preforms 530 presents an alternative example for forming an alternative example 1000U to the molded device 1000. For example, one or more U-shaped preforms 530 are comprised in one or more of the angle plates 1001, for example in each of the angle plates 1001-1, 1001-2. For example, one or more of the U-shaped preforms 530 are orthogonal to the based plate 1000B. For example, one or more of the U-shaped preforms 530 are orthogonal to the first preform 510, 510-30 having a crenelated contour. For example, in the molded device 1000U comprising one or more angle plates comprising one or more U-shaped preforms 530, one or more of the first straight or vertical portions 530U1 of the U of the U-shaped preforms 530 are one or more of blended into, enmeshed, and woven into the first leg 510A1, for example as a parallel arrangement of fibers by compression of the crenelated legs with straight portions of the U's. For example, in the molded device 1000U comprising one or more angle plates comprising one or more U-shaped preforms 530, one or more of the second straight or vertical portions 530U2 of the U of the U-shaped preforms 530 are blended into the second leg 510A2.

For example, a method for forming the molded device 1000U comprises a step of positioning one or more of the U-shaped preforms 530 into the mold 8000, for example vertically, for example with the straight portions 530U1, 530U2 extending towards an open portion of the mold, for example upwards. For example, the method for forming the molded device 1000U comprises a step of positioning a preform 510 comprising one or more crenellations into the mold. For example, the straight portions 530U1, 530U2 are comprised in a plane that intersects one or more of the crenellations of the preform 510, for example orthogonally. For example, the method further comprises adding one or more of pellets and organosheets into the mold. For example, the method further comprises closing the mold, for example by applying pressure, for example in a step of compression molding.

For example, one or more of the angle plates 1000, 1000U are used in a rigging, for example comprised in a building structure, a vehicle, an aircraft, or a ship. The geometry of the angle plate should not be considered as limiting: the compression molding process is, for example, used to distort the first preform into bodies comprising one or more of curved and twisting geometries. For example, the description for forming an angle plate is adapted, per mold geometry, for forming, for example, one or more fan blades, for example comprising a spanwise twist, for example along a direction intersecting the base plate, for example along a direction orthogonal to the base plate. As another or combinable example, the base plate comprises one or more of a curved and a twisting geometry, for example to provide a surface that matches a curved surface, for example to provide a bonding surface, as for example for bonding to the inside or the inside of a curved surface, for example an aircraft fuselage.

FIG. 4 is a block diagram of a control system 4000 for controlling a molding system 8000 for forming a molded device. For example, the control system comprises a processor 4110. For example, the processor 4110 comprises instructions that generate commands sent via a data bus 4150 to actuators 4180, for example one or more of the compression actuators 4182, 8132A and temperature adjusting actuators 4181. For example, the processor 4110 comprises instructions to receive data from one or more sensors 4170, for example one or more temperature sensors 4171 and pressure, force, or torque sensors, for example related to the motion of the compression actuators 4182. For example, the control system comprises one or more memory 4160 and non-transitory storage medium or devices 4120, for example for storing one or more of data and instructions. For example, the control system comprises a user interface 4130, for example for specifying one or more of: a temperature sequence as a function of one or more of position of the actuators 4180, 4182, 8132A, measured temperature, time of the day, and elapsed time; and a position sequence of one or more actuators 4180, 4182, 8132A as a function of one or more of the temperature sequence, one or more of the measured temperature at one or more of the temperature sensors 4171, time of the day, elapsed time, and the pressure, force, or torque sensors. For example, the control system 4000 comprises a communications interface 4140, for example a wireless interface, for example to exchange data with an external system 4200, for example for receiving command from a remote control system, a remote server, for example that generates a sequence of instructions to control the method 5000 to form a device, for example to form the device 1000, or a remote operator using a user interface 4130.

The specification and drawings are, accordingly, to be regarded in an illustrative rather than a restrictive sense. It will, however, be evident that various modifications and changes are, for example, made thereunto without departing from the broader spirit and scope of the disclosure as set forth in the claims. Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this disclosure are described herein, including the best mode known to the inventors for carrying out the invention. Variations of those preferred embodiments become, for example, apparent upon reading the foregoing description. The inventors expect skilled artisans to employ such variations as appropriate and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-45. (canceled)

46. A mold system for forming a molded device comprising an angle plate, comprising:
a first mold component comprising at least a first surface internal to the mold;
a second mold component comprising one or more wells; and
one or more actuators connected to one or more of the first mold component and the second mold component;
wherein one or more of the first mold component and the second mold component comprises a guiding rail oriented along a Z-axis; and
the one or more wells comprise one or more clamps in sliding contact with a guide rail oriented along an X-axis.

47. A device comprising:
one or more angle plates arranged in a third direction (−Z) with respect to a base plane (X-Y) of a base plate, comprising one or more first preforms arranged in the base plane and having a crenelated contour comprising a stack comprising one or more layers comprising one or more tows arranged along one or more of the contours of the first preform, the crenelated contour comprising one or more crenellations having crenellation extremities deflected in the third direction and lodged into the angles plates.

48. The device of claim 47, wherein the first preform forms a closed loop.

49. The device of claim 47, wherein one or more of the tows follow the contour of the first preform in a spiral path.

50. The device of claim 47, wherein one or more of the tows comprise one or more U-turns.

51. The device of claim 47, wherein one or more of the preforms follow a turning path around at least a portion of a periphery of one or more inserts.

52. The device of claim 47, wherein the first preform has one or more of:
a first straight portion from a first insert to a second insert;
a first crenelated portion from the second insert to a third insert;
a second straight portion from the third insert to a fourth insert; and
a second crenelated portion from the fourth insert to the first insert.

53. The device of claim 47, wherein a first leg and a second leg of one or more of the crenellations have a bonding with each other along at least a portion of the length of the legs.

54. The device of claim 47, wherein one or more of the angle plates comprise one or more U-shaped preforms.

55. The device of claim 54, wherein one or more of the U-shaped preforms have one or more straight portions of the U of the U-shaped preforms blended into one or more of the crenellations.

56. The device of claim 55, wherein:
a first straight portion of one or more of the U-shaped preforms is blended into one or more of the legs of a first crenellation arranged on a first side of the first preform; and
a second straight portion of the U-shaped preform is blended into one or more of the legs of a second crenellation arranged on a second side of the first preform.

57. The device of claim 56, wherein an extremity of the first crenellation faces an extremity of the second crenellation.

58. The device of claim 56, including one or more first crenellations and one or more second crenellations, wherein one or more of the first crenellations and one or more of the second crenellations form a point symmetrical arrangement.

59. The device of claim 47, wherein the base plate has a bonding surface having a curved surface.

60. The device of claim 47, wherein one or more of the angle plates have a spanwise twist.

61. The device of claim 47, further comprising a filler arranged against a curved portion of the deflected crenellation extremities.

62. The device of claim 47 configured as a pin bracket.

63. The device of claim 47, wherein the base plate has a curvature to match a curvature of a surface of an aircraft.

64. A method for forming an angle plate comprising one or more angle plates arranged in a third direction (−Z) with respect to a base plane (X-Y) of a base plate, the method comprising:
positioning in a mold one or more first preforms, the one or more first preforms comprising one or more tows configured with a crenelated contour, the one or more first performs comprising a layered stack, each layer comprising one or more tows arranged along one or more of the contours of the first preform, the crenelated contour comprising one or more crenellations having crenellation extremities; and
deflecting the crenellation extremities in the third direction by one or more of:
adding or positioning a filler into the mold;
heating the mold; and
displacing one or more components of the mold.

65. The method of claim 64, further comprising positioning one or more U-shaped preforms into the mold wherein straight portions of the U-shaped preforms are extending towards an open portion of the mold.

66. The method of claim 65, further comprising one or more of:
forming one or more of the first preforms by forming one or more of the crenellations arranged along one or more of the contours of the first preform by depositing one or more of the tows; and
forming one or more U-shaped preforms by depositing one or more tows in a stack comprising one or more layers comprising one or more of the tows.
